(19) United States
(12) Patent Application Publication
(10) Pub. No.: US 2026/0275993 A1
(43) Pub. Date: Sep. 17, 2026

(54) METHOD FOR CONTROLLING THE OPERATING PARAMETERS OF A TURBOMOLECULAR VACUUM PUMP

(71) Applicant: PFEIFFER VACUUM, Annecy (FR)

(72) Inventors: Pierre-Emmanuel CAVAREC, Annecy Cedex (FR); Hisanori KAMBARA, Annecy Cedex (FR); Nicolas VARENNES, Annecy Cedex (FR); Cécile CHAVANNE, Annecy Cedex (FR)

(73) Assignee: PFEIFFER VACUUM, Annecy (FR)

(21) Appl. No.: 19/167,716

(22) PCT Filed: Jan. 22, 2024
(86) PCT No.: PCT/EP2024/051399

§ 371 Date: Sep. 22, 2025

(30) Foreign Application Priority Data
Mar. 30, 2023 (FR) FR2303059

(51) Int. Cl. F04D 27/00; F04D 19/04; F04D 29/58

(52) U.S. Cl. CPC F04D 27/006; F04D 19/042; F04D 27/001; F04D 29/584; F05D 2270/303; F05D 2270/80

(57) ABSTRACT

A method controls the operating parameters of a turbomolecular vacuum pump including a stator, a rotor, a motor to drive the rotor in rotation in the stator, an internal heating device on the gas flow path of the vacuum pump to heat the rotor, a temperature sensor to measure the temperature of the rotor, and an external heating device to heat the stator. The control method includes a nominal operating mode in which the rotor is heated by the internal heating device as long as the measured temperature of the rotor is below a temperature threshold for a given parameter representative of the power consumed by the motor, and a boost operating mode in which the internal heating of the rotor is cut off when the measured temperature of the rotor is above or equal to the temperature threshold.

### TECHNICAL FIELD OF THE INVENTION

The present invention concerns a method for controlling the operating parameters of a turbomolecular vacuum pump. The present invention also concerns a turbomolecular vacuum pump.

### TECHNICAL BACKGROUND

Generating a high vacuum in an enclosure necessitates the use of turbomolecular vacuum pumps consisting of a stator inside which a rotor is driven in rapid rotation, for example in rotation at more than thirty thousand revolutions per minute.

In some processes in which turbomolecular vacuum pumps are used, such as processes for the manufacture of semiconductors, photovoltaic panels or LED, a layer of deposit can be formed in the vacuum pump. These deposits can lead to a restriction of the clearance between the stator and the rotor that can cause seizure of the rotor. It is known to heat the stator to prevent the condensation of reaction products and thus to limit the formation of deposits in the vacuum pump and to increase its service life.

As well as limiting the formation of deposits, it can be necessary to increase the operating temperature of the rotor for other reasons. In fact, increasing the temperature may for example be necessary to enable the flow of gas to be pumped to be increased or to facilitate the pumping of heavier gas species.

Care is nevertheless taken so that the temperature of the rotor does not exceed a certain high threshold in order to preserve its mechanical strength. In fact, the mechanical resistance of the rotor to centrifugal forces decreases as the temperature increases. Irreversible deformation (known as creep) of the rotor can occur at high temperatures and risks causing the most expanded part of the rotor to touch the stator. Also attempted is preventing excessive heating of the pumped gases to limit the risks of thermal cracking, that is to say chemical degradation of the molecules of the pumped gases if they are heated excessively, with production of non-volatile byproducts such as carbon black.

Furthermore, if a heated vacuum pump is confronted at the inlet with a high gas flow to be pumped leading to overloading of the motor that cannot be absorbed by the vacuum pump the vacuum pump limits the rotation speed of the rotor until the pumping load falls below a tolerable threshold again. The pumping capacity of the turbomolecular vacuum pump is therefore reduced in these particular situations for the time taken to absorb these high gas flows.

### SUMMARY OF THE INVENTION

One object of the present invention is to propose a method for controlling the operating parameters of a turbomolecular vacuum pump with optimized heating, in particular for pumping alternating cycles of periods with high gas flows to be pumped and periods with moderate gas flows to be pumped.

To this end, the invention has for object a method of controlling the operating parameters of a turbomolecular vacuum pump including:
a stator,
a rotor,
a motor configured to drive the rotor in rotation in the stator,
an internal heating device on the gas flow path of the vacuum pump configured to heat the rotor,
a temperature sensor configured to measure the temperature of the rotor,
an external heating device configured to heat the stator, characterized in that the control method includes:
a nominal operating mode in which the rotor is heated by the internal heating device as long as the measured temperature of the rotor is below a temperature threshold for a given parameter representing the power consumed by the motor, and
a boost operating mode in which the internal heating of the rotor is cut off when the measured temperature of the rotor is above or equal to the temperature threshold.

The temperature threshold depends on the parameter representing the (electric) power consumed by the motor, which can be the current or the power consumed by the motor. The electric power consumed by the motor is itself representative of the gas flow to be pumped. The higher the flow to be pumped the higher the power consumed by the motor and vice versa.

It is therefore possible to vary the temperature threshold with the power consumed and therefore with the gas flow to be pumped to activate or to reactivate heating so that the temperature remains in a given temperature range related to the quantity of gas flow to be pumped.

Accordingly, if the vacuum pump is used in pumping cycles alternating periods of high flows to be pumped, that is to say gas flows above the nominal gas flows, for example at least 1.5 times greater than the latter, with periods of moderate and therefore nominal gas flows to be pumped, starting and cutting off internal heating can be synchronized with the variations of gas flow to be pumped. Instead of cutting off and re-establishing internal heating blind, that is to say instead of regulating the temperature taking account only of the temperature, the internal heating can be cut off during periods of high power (and therefore of high gas flows to be pumped). Taking into account the power consumed by the motor therefore enables a corresponding relationship to be established between periods with high gas flows and periods in which internal heating is cut off. Cutting off internal heating makes it possible to avoid excessive heating of the high gas flows to limit the risks of thermal cracking, that is to say chemical degradation of the molecules of the pumped gases if they are heated excessively, with the production of non-volatile byproducts such as carbon black.

The control method can further have one or more of the features that are described hereinafter, separately or in combination.

The temperature threshold is variable.

It is below a maximum temperature threshold. The maximum temperature threshold is for example between 130° C. and 140° C.

For example the temperature threshold increases, for example in a linear manner, within a given temperature range with the increase in the parameter representing the power consumed by the motor. The given temperature range is for example between 100° C. and 140° C., for instance between 118° C. and 120° C. Internal heating is cut off at a slightly lower temperature at high power than at low power to anticipate the upcoming increase in the temperature of the rotor due to the increased gas flow to be pumped, this increased gas flow to be pumped causing an increase in the temperature of the rotor because of the compression of the gas, although this is relatively slow.

The power consumed by the motor can level off at a maximum motor consumption threshold, for example 1000 W, or the current consumed by the motor can level off at a maximum motor consumption threshold, for example 10 A.

The power consumed in the boost operating mode is for example at least twice the power consumed in nominal operation.

In one example of an application the vacuum pump is used for the cyclic pumping of process chambers of equipment in which there take place production processes in production steps in which moderate gas flows are to be pumped and cleaning steps in which high gas flows are to be pumped.

The invention also has for object a turbomolecular vacuum pump including:
a stator,
a rotor,
a motor configured to drive the rotor in rotation in the stator,
an internal heating device on the gas flow path of the vacuum pump and configured to heat the rotor,
a temperature sensor configured to measure the temperature of the rotor,
an external heating device configured to heat the stator, characterized in that the motor is configured on the one hand to be able to drive the rotor with a nominal power and on the other hand to be able to drive the rotor with a boost power greater than the nominal power and the vacuum pump includes a control unit configured to execute a control method as described above.

The nominal rotation speed of the rotor can therefore be maintained with no particular risk to the service life of the vacuum pump. The boost operating mode is automatic, so the user does not need to change the temperature setpoint of the vacuum pump or to be aware of information external to the vacuum pump such as the duration, flowrate and nature of the pumped gases.

The turbomolecular vacuum pump can further have one or more of the following features described hereinafter, either separately or in combination.

The motor can be configured to supply a nominal power suitable for being able to pump a nitrogen equivalent continuous maximum flow less than 5 Pa·m³/s. The nominal power is for example between 80 W and 200 W.

The motor can be configured to supply a boost power suitable for being able to pump a nitrogen equivalent flow greater than or equal to 5 Pa·m³/s, for example greater than or equal to 6.755 Pa·m³/s. The boost power is for example at least twice the nominal power. It is for example greater than 600 W.

The temperature sensor is for example an infrared temperature sensor.

The internal heating device includes for example radiant elements arranged in helical grooves of a sleeve of the stator of the vacuum pump. The radiant internal heating device has the advantage of a short response time so that the heating can be cut off in less than one minute after the command to shut it down.

### BRIEF DESCRIPTION OF THE FIGURES

Other advantages and features of the invention will become apparent on reading the following description of one particular embodiment of the invention, which is in no way limiting on the invention, and from the appended drawings, in which:

FIG. 1 is a view in axial section of a turbomolecular vacuum pump.

FIG. 2 is a block schematic of elements of the vacuum pump from FIG. 1.

FIG. 3 is a block schematic of equipment connected to a turbomolecular vacuum pump itself connected to a primary pumping unit.

FIG. 4 is a graph showing one example of the temperature threshold (on the ordinate axis, in degrees Celsius) varying with the power consumed by the motor (on the abscissa axis, in watts).

FIG. 5 is a graph showing as a function of time (in minutes), for a turbomolecular vacuum pump used for pumping a process chamber in which takes place a production process in which production steps alternate with cleaning steps:
a curve A showing the evolution of the measured temperature of the rotor (left-hand ordinate axis, in degrees Celsius),
a curve B showing the evolution of the power consumed by the motor (right-hand ordinate axis, in watts),
a curve C showing the supply of power to the radiant elements of the internal heating device of the vacuum pump (right-hand ordinate axis, in watts), and
a curve D showing the evolution of the temperature threshold (left-hand ordinate axis, in degrees Celsius).

In the above figures identical elements bear the same reference numbers.

### DETAILED DESCRIPTION

The following embodiments are examples. Although the description refers to one or more embodiments this does not necessarily mean that each reference concerns the same embodiment or that the features apply to only one embodiment. Single features of different embodiments can also be combined or interchanged to provide other embodiments without departing from the scope of the invention as defined by the claims.

By “upstream” is meant an element that is placed ahead of another relative to the direction of circulation of the gas. In contrast, by “downstream” is meant an element that is placed after another element relative to the direction of circulation of the gas to be pumped.

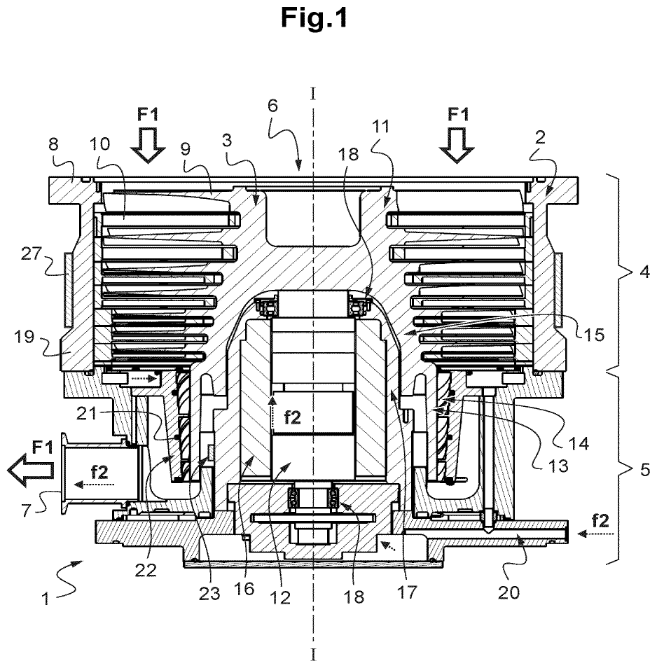

FIG. 1 depicts an embodiment of a turbomolecular vacuum pump 1.

The turbomolecular vacuum pump 1 includes a stator 2 inside which a rotor 3 is configured to rotate in axial rotation at high speed, for example in rotation at more than thirty thousand revolutions per minute.

In the FIG. 1 embodiment the turbomolecular vacuum pump 1 is a hybrid pump: it includes a turbomolecular stage 4 and molecular stage 5 situated downstream of the turbomolecular stage 4 in the direction of circulation of the pumped gases (represented by arrows F1 in FIG. 1). The pumped gases enter via the suction port 6, pass first through the turbomolecular stage 4 and then the molecular stage 5, and are then evacuated toward a discharge port 7 of the turbomolecular vacuum pump 1. When the pump is operating the discharge port 7 is connected to a primary pumping unit.

For example an annular input flange 8 surrounds the suction port 6 to connect the vacuum pump 1 to an enclosure in which the pressure is to be reduced.

In the turbomolecular stage 4 the rotor 3 includes at least two stages of blades 9 and the stator 2 includes at least one stage of vanes 10. The blade stages 9 and the vane stages 10 are in axial succession along the rotation axis I-I of the rotor 3 in the turbomolecular stage 4. The rotor 3 includes for example more than four blade stages 9, for example between four and twelve blade stages 9 (seven in the embodiment depicted in FIG. 1).

Each blade stage 9 of the rotor 3 includes inclined blades that depart in a substantially radial direction from a hub 11 of the rotor 3 fixed, for example screwed, to a drive shaft 12 of the vacuum pump 1. The blades are regularly distributed at the periphery of the hub 11.

Each vane stage 10 of the stator 2 includes a ring from which depart in substantially radial directions inclined vanes regularly distributed on the interior perimeter of the ring. The vanes of a vane stage 10 of the stator 2 come to be engaged between the blades of two successive blade stages 9 of the rotor 3. The blades 9 of the rotor 3 and the vanes 10 of the stator 2 are inclined to guide the pumped gas molecules toward the molecular stage 5.

Here in the molecular stage 5 the rotor 3 further includes a skirt 13 known as a Holweck skirt downstream of the at least two blade stages 9 and formed by a smooth cylinder that rotates facing helical grooves 14 in the stator 2. The helical grooves 14 are arranged above one another. There are for example between three and ten helical grooves 14, for instance six grooves. The helical grooves 14 in the stator 2 enable the pumped gases to be compressed and guided toward the discharge port 7.

The rotor 3 further includes an internal bowl 15 coaxial with the rotation axis I-I, formed below the skirt 13 and facing a bell 17 of the stator 2 projecting below the rotor 3. In operation the rotor 3 turns in the stator 2 with no contact between the internal bowl 15 and the bell 17.

The rotor 3 can be made in one piece (monobloc) or consist of an assembly of several parts. It is for example made of aluminum (or aluminum alloy) and/or nickel. It can have a coating, such as a nickel coating, in particular for improved resistance to corrosion. It is for example made of nickel-plated aluminum.

The rotor 3 is driven in rotation in the stator 2 by a motor 16 of the vacuum pump 1. The motor 16 is for example inside the bell 17 of the stator 2 which is itself below the internal bowl 15 of the rotor 3, the drive shaft 12 passing through the bell 17 of the stator 2.

The rotor 3 is guided laterally and axially by magnetic or mechanical bearings 18 in the stator 2 supporting the drive shaft 12 of the rotor 3. There are for example first bearings 18 supporting and guiding a first end of the drive shaft 12 in a base of the bell 17 of the stator 2 and second bearings 18 supporting and guiding a second end of the drive shaft 12 at the top of the bell 17.

Other electrical or electronic components can be received in the bell 17 of the stator 2, such as position sensors.

The vacuum pump 1 can include a cooling device configured to cool the bell 17, for example inside the bell 17 or in thermal contact with the bell 17, such as a hydraulic circuit, in order to be able to cool continuously the elements that it contains such as in particular the bearings 18, the motor 16 and other electrical or electronic components, to enable them to function.

The vacuum pump 1 can include a purge device 20 configured to inject a purge gas into the interstice between the bell 17 of the stator 2 and the internal bowl 15 of the rotor 3. The purge gas is preferably air or nitrogen but can equally well be a neutral gas such as helium or argon. The purge device is for example configured to inject a purge gas at the level of at least one bearing 18 in the stator 2 supporting and guiding the drive shaft 12 of the rotor 3 so that the flow of purge gas passes through the at least one bearing 18 before leaving the bell 17 of the stator 2, the purge gas circulating in this interstice. The circulation of the purge gas is schematically represented by arrows f2 in FIG. 1.

The vacuum pump 1 includes an internal heating device 21 on the gas flow path of the vacuum pump 1 and configured to heat the rotor 3.

The internal heating device 21 can include radiant elements, located for example in the helical groove 14 of a sleeve 22 of the stator 2 of the vacuum pump 1. The radiant internal heating device 21 has the advantage of a short response time so that heating can be cut off in less than one minute after the command to shut it down.

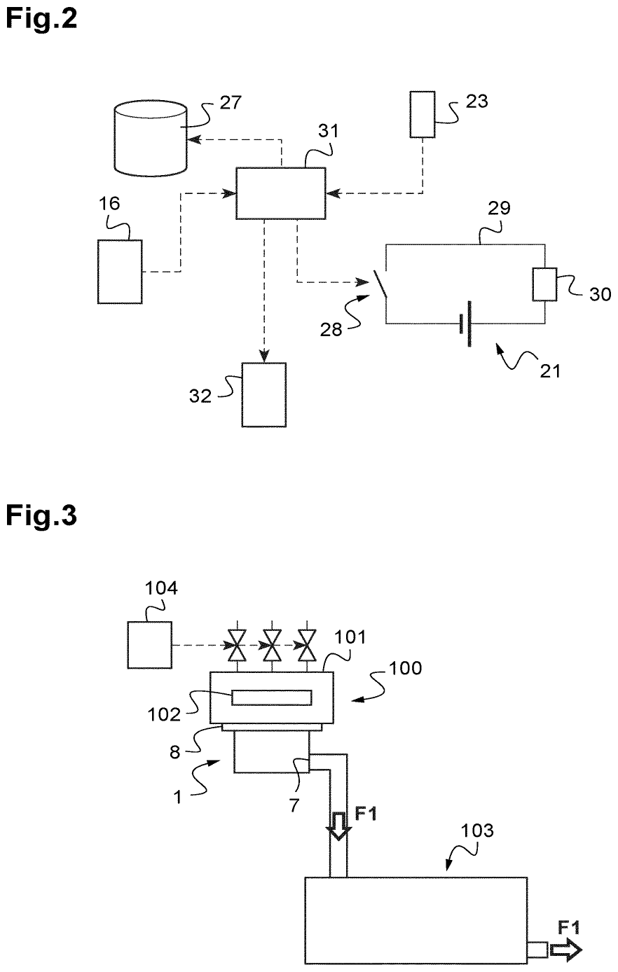

The internal heating device 21 includes for example on the one hand an electric circuit 29 including at least one resistive element, known as a radiant element 30, not in thermal contact with the stator 2 but capable of evacuating heat by infrared radiation, the radiant elements 30 being inserted in the facing pumped gas path of the rotor 3, and on the other hand a switch 28 electrically connected to the electric circuit 29 and controlled by a control unit 31 of the vacuum pump 1 to allow or to cut off the supply of electrical power to the radiant elements 30 (FIG. 2).

The turbomolecular vacuum pump 1 further includes a temperature sensor 23 configured to measure the temperature of the rotor 3. The temperature sensor 23 is for example an infrared temperature sensor. The infrared sensor is contactless, enabling highly accurate measurement of the temperature of the rotating rotor 3 in temperature ranges between 50° C. and 250° C.

The temperature sensor 23 can be configured to measure the temperature of the skirt 13 (the cylindrical part) of the rotor 3, in particular in a low part thereof, that is to say a part situated on the side of the discharge port 7 of the vacuum pump 1, so as to target the part of the rotor 3 that suffers the highest mechanical stresses.

The temperature sensor 23 is for example arranged behind (below) the skirt 13 of the rotor 3, between the stator 2 and the internal bowl 15 of the rotor 3 (FIG. 1). In this way the temperature sensor 23 is not on the gas pumping path and is therefore not greatly subjected to corrosive attack by the pumped gases and can benefit from the protection afforded by the purge gas.

The vacuum pump 1 also includes an external heating device 27 configured to heat the stator 2 of the vacuum pump 1.

The external heating device 27 is for example configured to heat the external envelope 19 (or casing) of the stator 2 of the vacuum pump 1. Alternatively or additionally the external heating device 27 can be configured to heat the stator 2 at the level of the discharge port of the vacuum pump 1, in particular around the discharge port 7.

The external heating device 27 includes for example one or more heating resistive belts or one or more heating cartridges, the supply of electrical power to which can be controlled by the control unit 31, independently of the internal heating device 21. Heating can in particular be controlled around a setpoint temperature by means of an additional temperature sensor configured to measure the temperature of the stator 2. The regulation time constant of the external heating device 27 is much higher than the regulation time constant of the internal heating device 21 because of the difference in the response times of the temperature sensors and the heating devices.

The motor 16 is on the one hand configured to be able to drive the rotor 3 with nominal power. The nominal power is matched to the mechanical characteristics of the rotor 3 and to pumping a continuous maximum gas flow at the nominal rotation speed. It is considered that the nominal power is a mean value. It is for example between 80 W and 200 W. The nominal power is generally defined by a continuous nitrogen or argon equivalent maximum gas flow to be pumped. These values are generally indicated by the manufacturer and available in the user manual or in the technical data sheet of the vacuum pump 1. They enable the user to choose a vacuum pump suitable for the gas flow to be pumped.

For example the motor 16 is configured to furnish a nominal power able to pump a continuous maximum (nitrogen equivalent) flow below 3000 sccm (or 5 Pa·m³/s).

On the other hand the motor 16 is configured to be able to drive the rotor 3 with boost power above the nominal power. This boost power is called for in limited time periods, for example less than fifteen minutes, and under certain conditions of heating of the rotor 3.

The boost power is for example at least twice the nominal power. It is for example greater than 600 W.

For example the motor 16 is configured to supply a boost power making it able to pump a nitrogen equivalent flow greater than or equal to 3000 sccm (or 5 Pa·m³/s), such as 4000 sccm (or 6.755 Pa·m³/s), whereas the mechanical characteristics of the rotor 3 make it able to pump a continuous maximum flow of less than 3000 sccm (or 5 Pa·m³/s).

The motor 16 is uprated relative to the mechanical characteristics of the rotor 3, which are suitable for nominal operation.

The control unit 31, such as an electronic circuit card, includes one or more controllers or microcontrollers or processors and a memory for executing sequences of program instructions enabling use of the method of controlling the operating parameters of the turbomolecular vacuum pump 1, in particular by controlling the internal heating device 21. The control unit 31 is for example located in the base of the stator 2 and cooled by the cooling device.

The control method includes a nominal operating mode in which the rotor 3 of the vacuum pump 1 is heated by the internal heating device 21 as long as the measured temperature of the rotor 3 is below a temperature threshold for a given parameter representing the power consumed by the motor 16.

The control method includes a boost operating mode in which the internal heating of the rotor 3 is cut off when the measured temperature of the rotor 3 is above or equal to the temperature threshold.

The temperature threshold depends on the parameter representing the (electrical) power consumed by the motor 16, which can be the current or the power consumed by the motor 16. The electrical power consumed by the motor 16 is itself representative of the gas flow to be pumped. The higher the flow to be pumped the higher the power consumed by the motor 16 and vice versa.

For example, the power consumed in boost operating mode can be at least twice the power consumed in nominal operation.

The temperature threshold is below a maximum temperature threshold. The maximum temperature threshold is for example between 130° C. and 140° C. It is a high threshold that is not to be exceeded in order to preserve the mechanical strength of the rotor 3.

The temperature threshold is variable. It depends on the parameter representative of the power consumed by the motor 16, such as the power or the current consumed by the motor 16 over a given temperature range.

For example the temperature threshold decreases, for instance in a linear manner, as the parameter representative of the power consumed by the motor 16 in the temperature range increases. The higher the power or the current consumed by the motor 16 the more rapidly is the internal heating cut off.

The given temperature range is for example between 100° C. and 140° C. or between 100° C. and a temperature at least 10° C. below the maximum temperature threshold, such as a temperature between 100° C. and 120° C., for example between 118° C. and 120° C. Before the lower limit of the temperature range is reached there is a risk of deposits being formed in the vacuum pump 1. Above the upper limit of the temperature range there is a risk of the rotor 3 suffering creep.

The power (or the current) consumed by the motor 16 can level off at a maximum motor consumption threshold. The maximum motor consumption threshold is for example 1000 W (or 10 A).

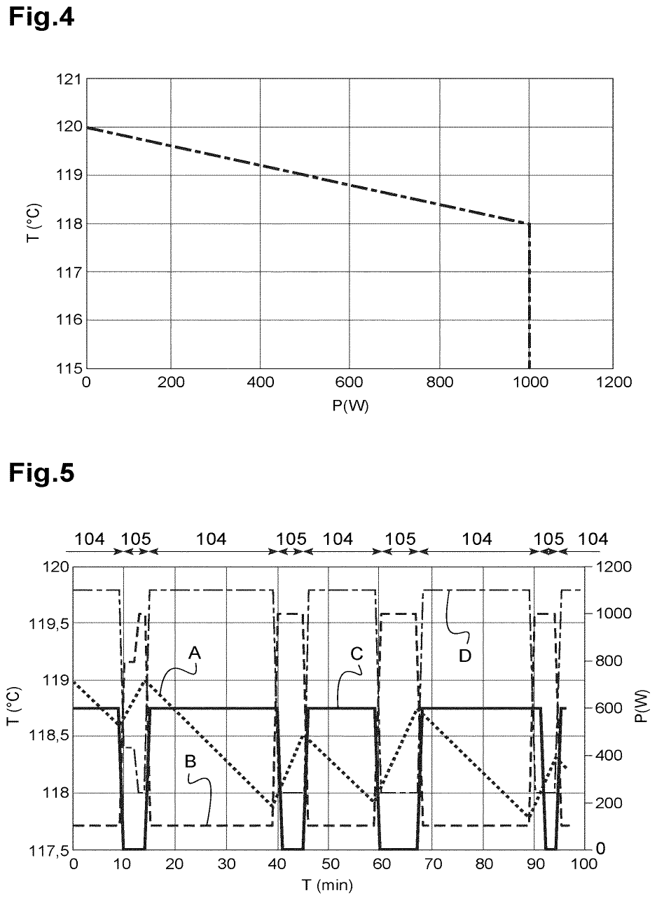

For example, and as represented in FIG. 4, if over the given power range from 0 to 1000 W the power consumed by the motor 16 is very high, for example at the maximum motor consumption threshold, here 1000 W, the temperature threshold above which the internal heating is cut off can be a lower limit of the given temperature range, for example 118° C. If the power consumed by the motor 16 is very low, for example zero, the temperature threshold above which the internal heating is cut off can be an upper limit above the lower limit, for example 10° C. below the maximum temperature threshold, such as 120° C. Between the two extreme powers of the given range the temperature threshold above which the internal heating is cut off can evolve in a linear manner with the power, in accordance with the following formula:

$$Temperature threshold = 120 ( ° C . ) - 0.002 ( ° C . / W ) * {P}_{motor} ( W )$$

If the parameter representative of the power consumed by the motor 16 is the current the temperature threshold can evolve in accordance with following formula:

$$Temperature threshold = 120 ( ° C . ) - 0.2 ( ° C . / A ) * {I}_{motor} ( A )$$

In operation the control unit 31 actively controls on the one hand the external heating device 27 for heating the external envelope 19 of the stator 2 and on the other hand the internal heating device 21 by controlling the supply of electrical power to the radiant elements 30. The temperature of the rotor 3 of the vacuum pump is measured by the temperature sensor 23 and a parameter representative of the power consumed by the motor 16, such as the electrical power or the current, is determined. To be sufficiently reactive determination of the temperature of the rotor 3 is more appropriate than determination of the temperature of the stator 2. These (measured temperature and current or power consumed) signals are sent to the control unit 31.

Accordingly, when the vacuum pump 1 is used in pumping cycles alternating periods of high gas flows to be pumped, that is to say gas flows greater than the nominal gas flows, for example at least 1.5 times greater than the latter, with periods of moderate, and therefore nominal, gas flows to be pumped starting and cutting off the internal heating can be synchronised with the variations of the gas flow to be pumped. Instead of cutting off and re-establishing the internal heating blind, that is to say instead of regulating the temperature taking account only of temperature, the internal heating can be cut off during periods of high power (and therefore high gas flows to be pumped). Taking account of the power consumed by the motor 16 therefore enables a corresponding relationship to be established between the periods with high gas flows and the periods in which the internal heating is cut off. Cutting off the internal heating enables prevention of excessive heating of high gas flows to limit the risks of thermal cracking, that is to say chemical degradation of the molecules of the pumped gases if they are heated excessively, with the production of non-volatile byproducts such as carbon black.

With the temperature threshold decreasing as the parameter representative of the power consumed by the motor 16 increases over a given temperature range the internal heating is cut off at a slightly lower temperature at high power than at low power to anticipate the upcoming increase in the temperature of the rotor 3 due to the increase in the gas flow to be pumped, this increase in the gas flow to be pumped causing an increase in the temperature of the rotor 3 because of the compression of the gases, but is relatively slow. In fact, the rotor 3 being very slow to heat up, the increase in the pumped gas flow has an impact on the temperature of the rotor 3 (and therefore on cutting off the internal heating) only much later than the start of pumping this high gas flow, and continues well after the end of that pumping. The evolving temperature threshold enables stabilisation of heating while approaching the upper temperature limit as closely as possible to prevent the formation of deposits in the vacuum pump 1 while limiting the risks of thermal cracking and the risks of creep.

The uprated motor 16 can absorb this high gas flow.

It is therefore possible to absorb high gas flows without slowing down the rotor 3. The nominal rotation speed of the rotor 3 can therefore be maintained with no particular risk to the service life of the vacuum pump 1.

A signal can be given when the vacuum pump 1 enters the boost operating mode, that is to say when the internal heating of the rotor 3 is cut off because the temperature of the rotor 3 has passed the temperature threshold. To this end the control unit 31 can include a signalling device 32 configured to emit a signal such as an electric, electronic or light signal for signalling the entry into the boost operating mode.

The boost operating mode is quit to return to the nominal operating mode, that is to say internal heating is re-established, if the measured temperature of the rotor 3 decreases and falls below the temperature threshold. This situation is generated by the end of pumping the high gas flow. The boost operating mode is therefore of limited duration, for example greater than one minute and less than fifteen minutes.

In an application example represented in FIG. 3 the vacuum pump 1 is used for the cyclic pumping of a process chamber 101 of equipment 100 in which are carried out in particular processes of manufacturing semiconductor elements 102, photovoltaic panels or flat screens.

The annular inlet flange 8 of the turbomolecular vacuum pump 1 is fluidically connected to the process chamber 101 of the equipment 100 and the discharge port 7 is fluidically connected to a primary pumping unit 103 for example.

The production processes taking place in the process chamber 101 include various steps in succession over time, in particular production steps 104 and cleaning steps 105. The FIG. 5 graph depicts a production process alternating production steps 104 and cleaning steps 105.

The production steps 104 for example include in particular etching steps, waiting steps, etc. They necessitate pumping a moderate, and therefore nominal, gas flow, for example a flow less than 2 slm (or 3.37 Pa·m³/s).

Cleaning steps 105 are regularly inserted between the production steps 104 to clean the walls of the process chamber 101. These steps 105 necessitate the pumping of high gas flows, for example flows of oxygen, for example at a flowrate of the order of 4 slm (or 6.75 Pa·m³/s).

The cleaning steps 105 generally last a few minutes once or twice an hour.

In the FIG. 5 graph the curve A shows the evolution of the measured temperature of the rotor 3 of the vacuum pump 1 during the production process, curve B shows the evolution of the power consumed by the motor 16, curve C shows the power supplied to the radiant elements 30 of the internal heating device 21 of the vacuum pump 1, and curve D shows the evolution of the temperature threshold.

It is seen that during the production steps 104 the power consumed by the motor 16 (curve B) is of the order of 100 W. It is below 1000 W, the maximum motor consumption threshold.

The temperature threshold (curve D) for this consumed power of 100 W is 119.8° C. It is seen that during the production steps 104 the measured temperature of the rotor 3 (curve A) falls slowly because the gas flow to be pumped has gone from high to moderate. The measured temperature of the rotor is below this temperature threshold of 119.8° C.

The radiant elements are therefore supplied with power (curve C).

The vacuum pump 1 is in the nominal operating mode.

When a cleaning step 105 begins the power consumed increases sharply because of the high gas flow to be pumped (curve B), the power consumed levelling off at the maximum motor consumption of 1000 W.

The increase in the power consumed causes proportional lowering of the temperature threshold (curve D). The measured temperature of the rotor 3 increases gradually because of the high gas flow to be pumped.

If the measured temperature of the rotor 3 is above or equal to the temperature threshold (at the crossover of curves A and D) the vacuum pump 1 enters the boost operating mode, which cuts off the supply of power to the radiant elements 30 of the internal heating device 21 (curve C). The internal heating is cut off without waiting for a significant increase in the temperature of the rotor 3.

Throughout the cleaning step 105 the power consumed in boost operating mode is at least twice the power consumed in nominal operation, here ten times greater. The measured temperature of the rotor 3 increases but does not have time to go beyond the maximum temperature threshold of 130° C.

At the end of the cleaning step 105 the power consumed decreases because of the reduction of the gas flow to be pumped. The temperature also begins to fall, but less rapidly.

The decrease in the power consumed causes a proportional increase in the temperature threshold (curve D).

When the measured temperature of the rotor 3 falls below the temperature threshold (at the crossover of curves A and D) the vacuum pump 1 enters the nominal operating mode, which re-establishes the supply of power to the radiant elements 30 of the internal heating device 21 (curve C).

Starting and cutting off the internal heating can be synchronized with the variations of the gas flow to be pumped to regulate the temperature by cutting off the internal heating during periods of high power (and therefore of high gas flows to be pumped). The boost operating mode is automatic so the user does not have to change the temperature setpoint of the vacuum pump 1 and does not need to know information external to the vacuum pump 1 such as the duration, flow and nature of the pumped gases.

1-12. (canceled)

13. A method of controlling operating parameters of a turbomolecular vacuum pump including:
a stator,
a rotor,
a motor configured to drive the rotor in rotation in the stator,
an internal heating device on a gas flow path of the vacuum pump configured to heat the rotor,
a temperature sensor configured to measure the temperature of the rotor, and
an external heating device configured to heat the stator,
the control method comprising:
heating, in a nominal operating mode, the rotor by the internal heating device as long as the measured temperature of the rotor is below a temperature threshold for a given parameter representative of a power consumed by the motor, and
cutting off, in a boost operating mode, the internal heating of the rotor when the measured temperature of the rotor is above or equal to the temperature threshold.

14. The control method as claimed in claim 13, wherein the temperature threshold is variable and decreases within a given temperature range, with an increase in the parameter representative of the power consumed by the motor.

15. The control method as claimed in claim 14, wherein the given temperature range between 100° C. and 140° C.

16. The control method as claimed in claim 14, wherein the given temperature range between 118° C. and 120° C.

17. The control method as claimed in claim 14, wherein the decrease is linear.

18. The control method as claimed in claim 13, wherein the power consumed by the motor levels off at a maximum motor consumption threshold.

19. The control method as claimed in claim 13, wherein the power consumed in the boost operating mode is at least twice the power consumed in the nominal operating mode.

20. The control method as claimed in claim 13, wherein the parameter representing the power consumed by the motor is a current or the power consumed.

21. The control method as claimed in claim 13, wherein the vacuum pump is used for cyclic pumping of process chambers of equipment in which there take place production processes in production steps in which moderate gas flows are to be pumped and cleaning steps (in which high gas flows are to be pumped.

22. A turbomolecular vacuum pump, comprising:
a stator;
a rotor;
a motor configured to drive the rotor in rotation in the stator;
an internal heating device on a gas flow path of the vacuum pump configured to heat the rotor;
a temperature sensor configured to measure the temperature of the rotor; and
an external heating device configured to heat the stator,
wherein the motor is configured to:
drive the rotor with a nominal power, and
to drive the rotor with a boost power greater than the nominal power, and
wherein the vacuum pump includes a control unit configured to execute the control method as claimed in claim 13.

23. The turbomolecular vacuum pump as claimed in claim 22, wherein the motor is configured to supply a nominal power to pump a nitrogen equivalent continuous maximum flow less than 5 Pa·m³/s.

24. The turbomolecular vacuum pump as claimed in claim 22, wherein the motor is configured to supply a boost power to pump a nitrogen equivalent flow greater than or equal to 5 Pa·m³/s.

25. The turbomolecular vacuum pump as claimed in claim 22, wherein the motor is configured to supply a boost power to pump a nitrogen equivalent flow greater than or equal to 6.755 Pa·m³/s.

26. The turbomolecular vacuum pump as claimed in claim 22, wherein the temperature sensor is an infrared temperature sensor.

27. The turbomolecular vacuum pump as claimed in claim 22, wherein the internal heating device includes radiant elements arranged in helical grooves of a sleeve of the stator of the vacuum pump.
